(19) United States
(12) Patent Application Publication
(10) Pub. No.: US 2026/0086956 A1
(43) Pub. Date: Mar. 26, 2026

(54) CONFIDENTIAL COMPUTING OWNERSHIP CHECK

(71) Applicants: ATI Technologies ULC, Markham (CA); Advanced Micro Devices, Inc., Santa Clara, CA (US)

(72) Inventors: Anthony Asaro, Markham (CA); Nippon Raval, Markham (CA); Vidyashankar Viswanathan, Boxborough, MA (US)

(73) Assignees: ATI Technologies ULC, Markham (CA); Advanced Micro Devices, Inc., Santa Clara, CA (US)

(21) Appl. No.: 18/897,896

(22) Filed: Sep. 26, 2024

(51) Int. Cl. G06F 12/14; G06F 12/1009

(52) U.S. Cl. CPC G06F 12/1475; G06F 12/1009; G06F 12/1408

(57) ABSTRACT

The disclosed device includes a control circuit that translates a virtual address to a final physical address for a graphics processing unit memory. The control circuit can confirm that a guest making the translation request has ownership of the final physical address and return the final physical address if the translation request passes the ownership checks. Various other methods, systems, and computer-readable media are also disclosed.

### BACKGROUND

Computing devices, such as servers, often use virtual machines (VMs) to allow different computing contexts to use the computing devices' resources. Hypervisors can manage the virtual machines (e.g., guests or guest virtual machines) to maintain separation between guests. Confidential computing allows guest data to remain confidential (e.g., from other guests as well as from a hypervisor) as well as maintain guest data integrity even if the underlying hardware is shared between guests. However, such confidential computing mechanisms are often restricted such that certain hardware, such as a graphics processing unit (GPU) having its own processor and memory, are not available for confidential computing.

### BRIEF DESCRIPTION OF THE DRAWINGS

The accompanying drawings illustrate number of exemplary implementations and are a part of the specification. Together with the following description, these drawings demonstrate and explain various principles of the present disclosure.

FIG. 1 is a block diagram of an exemplary system for confidential computing ownership checks.

FIG. 2 is a block diagram of an exemplary graphics processing unit (GPU) memory architecture.

FIG. 3 is a block diagram of various tables for address translation, including guest and host page tables.

FIG. 4 is a block diagram of an address translation pipeline for an exemplary graphics processing unit (GPU) memory architecture.

FIG. 5 is a block diagram of another address translation pipeline for an exemplary graphics processing unit (GPU) memory architecture.

FIG. 6 is a flow diagram of an exemplary method for confidential computing ownership checks.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to confidential computing ownership checks, such as with respect to GPU hardware. As will be explained in greater detail below, implementations of the present disclosure confirm whether a guest has ownership of a final physical address for a GPU memory when translating a virtual address to the final physical address. If the ownership check passes, the final physical address can be returned for a subsequent memory request to the GPU memory. The systems and methods described herein advantageously provide confidential computing for guest data on a GPU memory.

In one implementation, a device for confidential computing ownership checks includes a control circuit configured to translate, in response to a translation request including a virtual address and a guest identifier, the virtual address to a final physical address. The final physical address can correspond to a graphics processing unit memory. The control circuit is also configured to confirm the guest identifier has ownership of the final physical address, and return, in response to the confirmation, the final physical address.

In some examples, the control circuit is further configured to return an ownership status with the final physical address. In some examples, the control circuit is further configured to return an encryption status with the final physical address.

In some examples, the control circuit is configured to translate the virtual address by translating a corresponding guest physical address using a reverse mapping table that maps the graphics processing unit memory with a system memory. In some examples, the control circuit is configured to translate the virtual address using a frame buffer mapping table that maps the graphics processing unit memory separately from a system memory.

In some examples, translating the virtual address to the final physical address includes translating, using a guest page table, the virtual address to a guest physical address, and translating, using a mapping table, the guest physical address to the final physical address. In some examples, confirming the guest identifier has ownership further includes determining, using the guest page table, that the final physical address corresponds to an encrypted memory, and determining, using the mapping table and in response to the final physical address corresponding to the encrypted memory, that the guest identifier has ownership of the final physical address.

In some examples, the guest page table includes an encryption status, and the mapping table includes an ownership status. In some examples, the control circuit is configured to convert a second virtual address to a private encrypted memory by updating the corresponding encryption status and ownership status. In some examples, the control circuit is further configured to return a fault in response to the guest identifier failing ownership confirmation.

In one implementation, a system for confidential computing ownership checks includes a memory, a processor, and a graphics processing unit that includes a graphics processing unit memory, and a control circuit. The control circuit is configured to (i) translate, in response to a translation request including a virtual address and a guest identifier, the virtual address to a final physical address corresponding to the graphics processing unit memory, (ii) confirm, based on an ownership status associated with the final physical address in a mapping table, the guest identifier has ownership of the final physical address, and (iii) return, in response to the confirmation, the final physical address.

In some examples, the control circuit is further configured to return an encryption status with the final physical address. In some examples, the mapping table corresponds to a reverse mapping table that maps the graphics processing unit memory with the memory. In some examples, the mapping table corresponds to a frame buffer mapping table that maps the graphics processing unit memory separately from the memory.

In some examples, translating the virtual address to the final physical address includes translating, using a guest page table, the virtual address to a guest physical address, and translating, using the mapping table, the guest physical address to the final physical address.

In some examples, confirming the guest identifier has ownership further includes determining, using the guest page table, that the final physical address corresponds to an encrypted memory, and determining, using the mapping table, that the guest identifier has ownership of the final physical address.

In some examples, the guest page table includes an encryption status. In some examples, the control circuit is configured to convert a second virtual address to a private encrypted memory by updating the corresponding encryption status and ownership status. In some examples, the control circuit is further configured to return a fault in response to the guest identifier failing ownership confirmation.

In one implementation, a method for confidential computing ownership checks includes (i) receiving a translation request including a guest identifier and a virtual address, (ii) determining a guest physical address from the virtual address and the guest identifier, (iii) determining a final physical address from the guest physical address, (iv) determining the guest identifier passes an ownership check for the final physical address, and (v) returning the final physical address in response to the guest identifier passing the ownership check.

Features from any of the implementations described herein can be used in combination with one another in accordance with the general principles described herein. These and other implementations, features, and advantages will be more fully understood upon reading the following detailed description in conjunction with the accompanying drawings and claims.

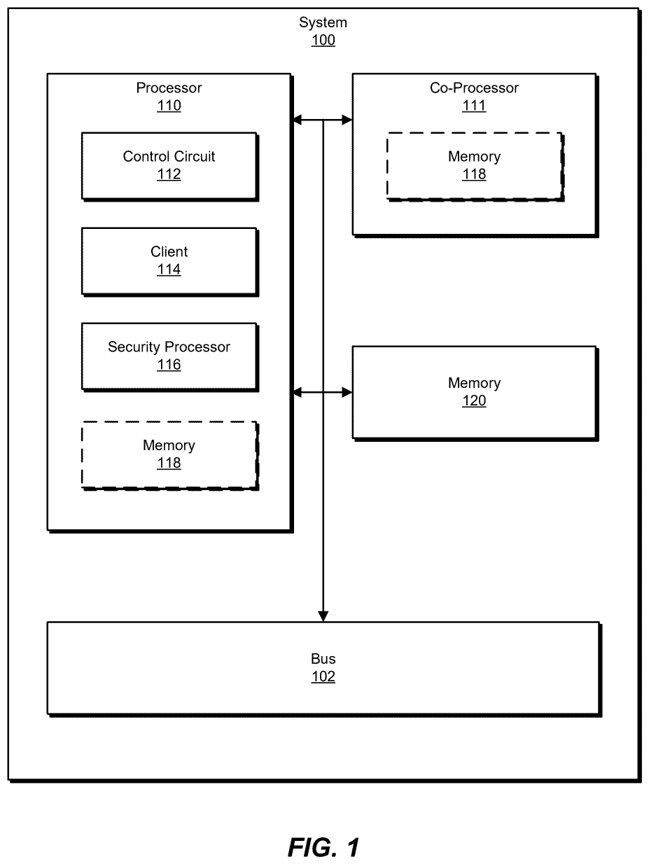

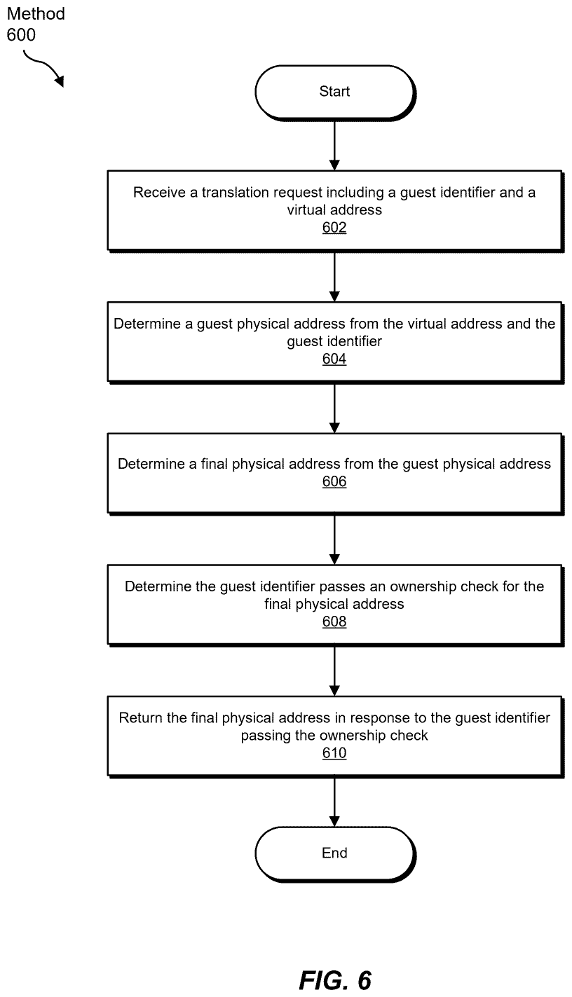

The following will provide, with reference to FIGS. 1-6, detailed descriptions of confidential computing ownership checks with respect to GPU memory. Detailed descriptions of example systems, architectures, and pipelines will be provided in connection with FIGS. 1-5. Detailed descriptions of corresponding computer-implemented methods will also be provided in connection with FIG. 6.

FIG. 1 is a block diagram of an example system 100 for confidential computing ownership checks. System 100 corresponds to a computing device, such as a server, a desktop computer, a laptop computer, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

As further illustrated in FIG. 1, processor 110 includes a control circuit 112, a client 114, a security processor 116, and a memory 118. Control circuit 112 corresponds to circuitry and/or instructions for implementing confidential computing ownership checks, which can correspond to, interface with, and/or be integrated with various controllers, such as a memory controller, a security processor (e.g., security processor 116), etc. Client 114 corresponds to a processing component/unit, although in some examples can also generally represent any processing component (e.g., outside of processor 110) and/or interface or controller for processing components used for confidential computing. Security processor 116 corresponds to a processing component that can be used for monitoring and maintaining a security environment, such as preventing firmware attacks, managing boot processes, monitoring for unusual changes to processor/instruction pipelines and data stored in memory, encryption/decryption, etc. Memory 118 corresponds to another memory or storage device (as described herein), which can be physically separate from memory 120. In some implementations, processor 110 can represent a GPU and memory 118 can represent a GPU memory thereof. In addition, although the examples described herein refer to a GPU and GPU memory, in other examples the GPU and GPU memory can correspond to an accelerator or other hardware.

In some examples, system 100 can provide confidential computing to guests (e.g., VMs) for protecting data stored in memory 120. For example, a controller (e.g., control circuit 112, security processor 116, and/or other controller for memory 120) can restrict access to guest data in memory 120 (e.g., the memory space holding the guest data) to only the guest owning the guest data (e.g., ownership privilege restricting control to only the guest which can further be encrypted to be made private), such that a hypervisor managing the guest and other guests are prevented from accessing the guest data. The systems and methods described herein allow extending similar confidential computing protections to guest data stored in memory 118.

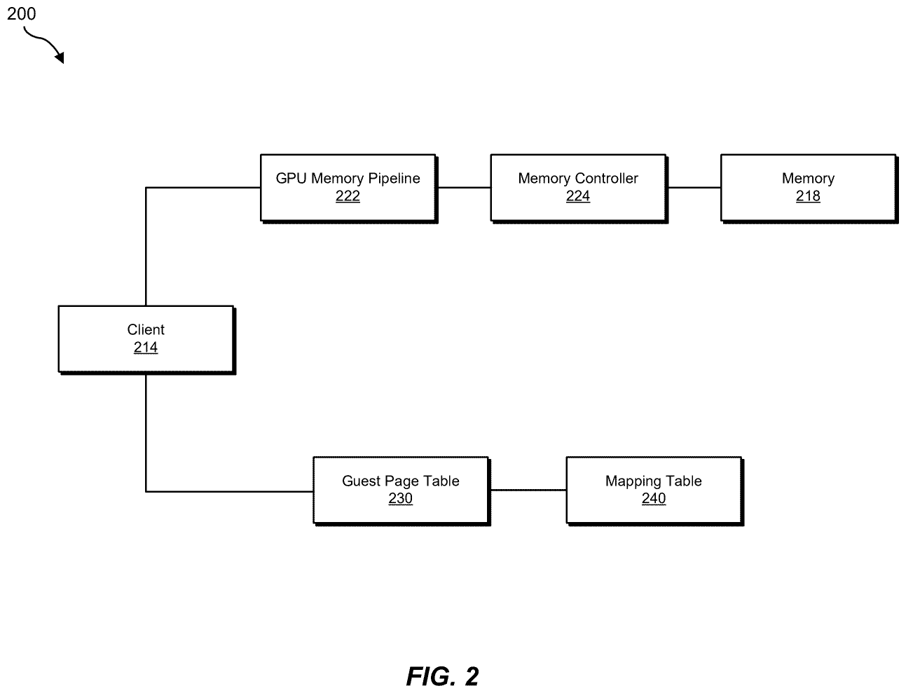

FIG. 2 illustrates a system 200 corresponding to system 100 and in some examples further corresponds to a basic memory request architecture with respect to a client 214 that corresponds to client 114. A top half of FIG. 2, including a GPU memory pipeline 222 (e.g., generally corresponding to a series of one or more processing components outputting to a next component), a memory controller 224 (e.g., a control circuit for accessing memory), and a memory 218 (e.g., a GPU memory and in some examples corresponding to memory 118), can correspond to a memory request flow, in some examples. A bottom half of FIG. 2, including a guest page table 230 (e.g., generally representing one or more structures such as page tables for translating or looking up a virtual address to a guest physical address) and a mapping table (e.g., generally representing one or more structures for translating or looking up a guest physical address to a final physical address), can correspond to a translation request flow, in some examples, as will be described further below.

Similar to system 100, system 200 can have a hypervisor and various guests running (e.g., via client 214 generally representing a hardware interface for memory operations for the guests and hypervisor), with one or more of the guests having confidential data requiring strict isolation (e.g., via encryption) from other guests or the hypervisor from accessing (e.g., reading, writing, copying, etc.). Each guest can be associated with a unique guest identifier which a control circuit (e.g., control circuit 112, security processor 116, and/or other controller) can use to distinguish between guests as well as the hypervisor.

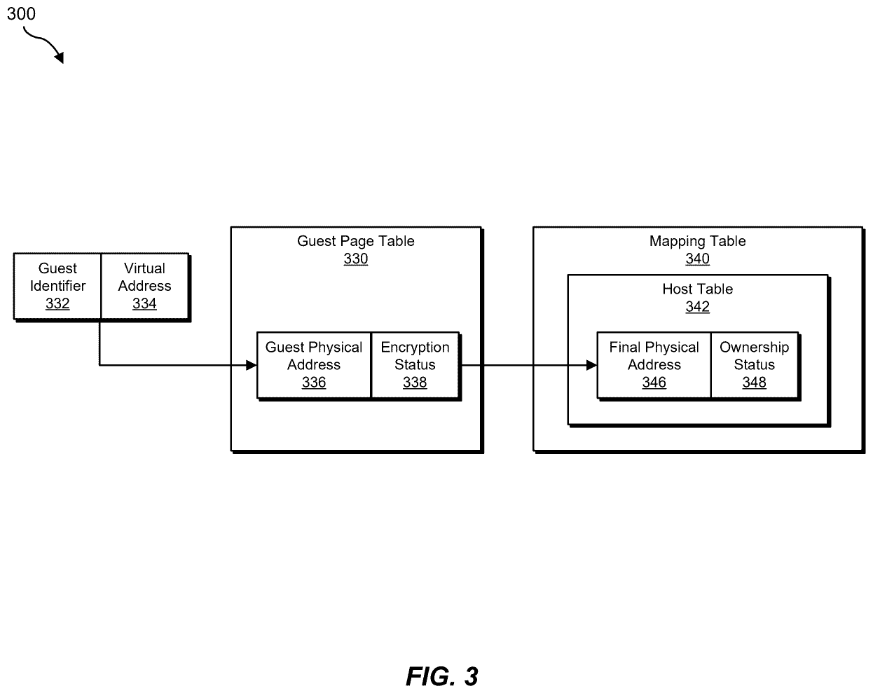

A guest can operate in its own memory space (e.g., range of memory addresses) which the hypervisor can, in part, manage, such as by establishing which guest memory addresses map to which physical addresses of memory devices. For example, when a guest requests memory, the hypervisor can coordinate with a controller (e.g., control circuit 112) to establish, using guest page table 230, a mapping from guest (or virtual) addresses to guest physical addresses (e.g., addresses corresponding to virtualized hardware for the guest). The hypervisor and/or control circuit can further establish, using mapping table 240, a mapping from guest physical addresses to final physical addresses that correspond to memory 218. FIG. 3 illustrates an example of such tables. Thus, having established ownership, the guest's memory space (e.g., physical addresses mapped to the guest addresses) can only be accessed by the guest.

FIG. 3 illustrates a system 300 corresponding to system 100 and/or a portion thereof, that includes a guest page table 330 (corresponding to guest page table 230) and a mapping table 340 (corresponding to mapping table 240, and in some implementations represents a host page table) for a guest identifier 332 and a virtual address 334. For illustrative purposes, guest page table 330 includes a single entry that includes a guest physical address 336, and an encryption status 338, although in other examples these values can be spread across various tables. For illustrative purposes, mapping table 340 includes a single host table 342 having a single entry that includes a final physical address 346 and an ownership status 348 (e.g., indicating whether a guest virtual machine has ownership privilege of the physical address). However, in other examples, each table can include multiple different entries as well as multiple different tables and/or levels of tables.

Guest page table 330 corresponds to one or more tables for managing which processes within a guest are assigned with pages (and/or other units of memory). Guest identifier 332 can correspond to a unique identifier for distinguishing between guests and/or hypervisors. Virtual address 334 can correspond to a guest virtual address in an address space of a guest corresponding to guest identifier 332. For example, software running on the guest can use the guest address space. Guest physical address 336 corresponds to a virtual physical address that can be established by the guest, and in some examples corresponds to a page or other unit of memory. Encryption status 338 can correspond to a flag, bit, etc. for indicating whether the associated guest physical address 336 and/or virtual address 334 is encrypted, as will be described further below.

Mapping table 340 corresponds to one or more tables for managing which physical addresses are assigned to which guests. Host table 342 corresponds to a table for managing addresses for a particular guest (e.g., a range of guest physical addresses for the guest associated with guest identifier 332 for the mapping depicted in FIG. 3). Final physical address 346 corresponds to a physical hardware address (e.g., of memory 118 and/or memory 218) mapped to guest physical addresses (e.g., guest physical address 336 for the mapping depicted in FIG. 3). Ownership status 348 corresponds to a flag, bit, etc. for indicating an ownership status of final physical address 346, as will be described further below.

In some examples, the guest can request a guest private page (e.g., a private encrypted memory such as a page that only the guest can access, which is not accessible to the hypervisor) such that the guest may decide which pages are private. The hypervisor can provide a new page or convert a page assigned to the guest to the requested private page. For example, the control circuit can convert virtual address 334 into the guest private page by updating encryption status 338 to indicate encryption (e.g., from an unencrypted state) and ownership status 348 to indicate that only the guest can access the corresponding page, in order to keep ownership status 348 consistent with the guest's view of the page. An encrypted status can correspond to the physical address (e.g., final physical address 346) in hardware (e.g., memory 218) is encrypted, which in some examples can be managed by memory controller 224 and/or memory 218 using an appropriate encryption scheme. An ownership status can indicate whether the corresponding physical address (e.g., final physical address 346) is valid for a particular guest (e.g., guest identifier 332) or the hypervisor (also corresponding to a shared page), such as to allow the hypervisor (and in some examples any guest) to access and later assign the physical address to a guest.

Returning to FIG. 2, when a guest accesses memory or otherwise performs a memory operation (e.g., via client 214), the request can include a guest identifier (e.g., guest identifier 332) and a virtual address (e.g., virtual address 334), which can undergo an address translation phase to determine a final physical address (e.g., final physical address 346) for a memory request phase.

In response to a translation request for the translation phase, the control circuit can translate the virtual address to the final physical address, using guest page table 230. As described herein with respect to FIG. 3, the control circuit can use guest page table 330 to translate virtual address 334 (received with the translation request) to guest physical address 336 (associated with guest identifier 332 also received with the translation request). The control circuit can also translate, using mapping table 340, guest physical address 336 to final physical address 346. In some example, final physical address 346 can correspond to a physical location in a memory of a GPU (e.g., memory 118 of co-processor 111) that is separate from a main system memory (e.g., memory 120).

The control circuit can further confirm that the guest (e.g., as represented by guest identifier 332) has ownership of final physical address 346 (e.g., an ownership privilege of final physical address 346). For instance, the control circuit can determine, using guest page table 330, that final physical address 346 corresponds to an encrypted memory, based on encryption status 338. In response to final physical address 346 corresponding to encrypted memory (as indicated by encryption status 338), the control circuit can determine, using mapping table 340, that guest identifier 332 has ownership of final physical address 346, for instance when ownership status 348 indicates a guest valid page as opposed to a hypervisor page. In some examples, ownership status 348 does not include any identifier to the guest owning final physical address 346 as host table 342 can be unique to guest identifier 332. In other words, another guest would not have a mapping leading to this particular final physical address 346 in this particular host table 342. However, in other examples, ownership status 348 can explicitly include a guest identifier similar to guest identifier 332.

Based on passing the ownership checks (e.g., encryption status 338 indicating that final physical address 346 is encrypted such that its ownership should be checked, and ownership status 348 indicating that final physical address 346 is a guest page rather than a hypervisor page) the control circuit can return final physical address 346 (e.g., to client 214) to complete the translation phase and send the memory request with final physical address 346 to memory 218. In some examples, the control circuit can also return encryption status 338 and/or ownership status 348 with final physical address 346, which can be sent with the memory request and used by memory controller 224 and/or memory 218 as needed to complete the memory request.

However, the ownership checks or confirmation can also fail, such as when the various statuses are inconsistent. For example, encryption status 338 can indicate final physical address 346 should be encrypted (indicating a guest private page) while ownership status 348 indicates a hypervisor/shared page rather than a guest page. In another example, encryption status 338 can indicate an unencrypted page while ownership status 348 indicates a guest/private page (rather than a hypervisor/shared page consistent with an unencrypted page). In such instances, the control circuit can return an appropriate fault.

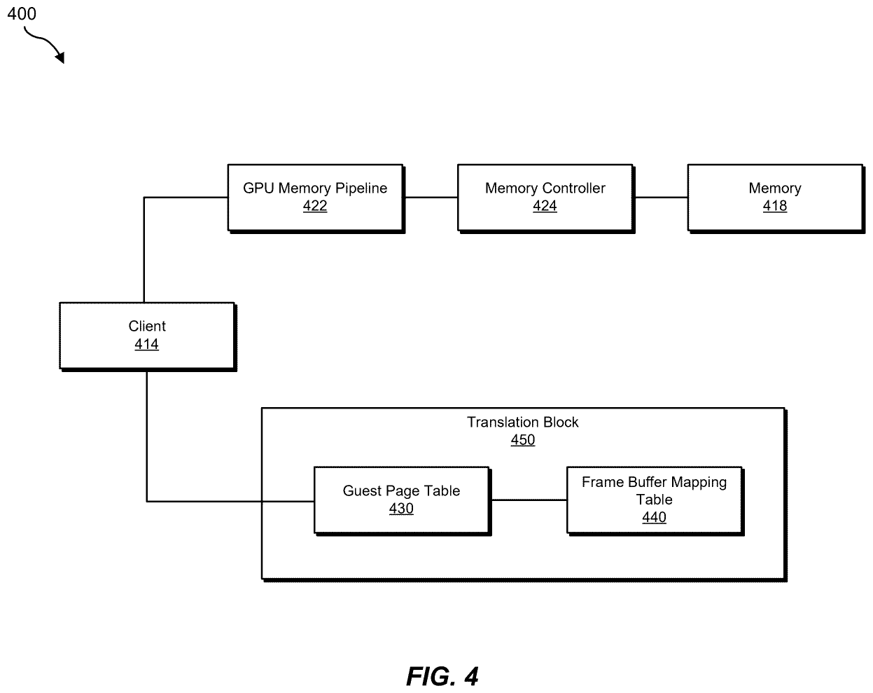

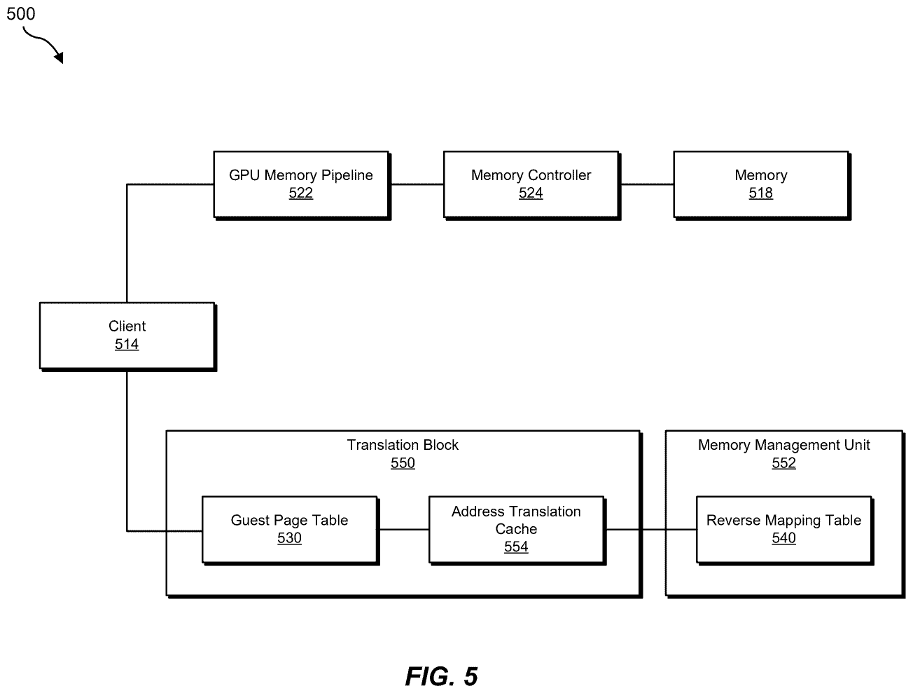

Although FIG. 2 illustrates a general architecture for confidential computing extended to GPU hardware, in some implementations, other architectures can be used, as will be described further with respect to FIGS. 4 and 5. FIG. 4 illustrates a system 400 that corresponds to system 100. System 400 includes a client 414 corresponding to client 114, a GPU memory pipeline 422 corresponding to GPU memory pipeline 222, a memory controller 424 corresponding to memory controller 224, and a memory 418 corresponding to memory 218. System 400 also includes a guest page table 430 corresponding to guest page table 230, and a frame buffer mapping table 440 corresponding to mapping table 240.

In some examples, system 400 corresponds to a GPU in which its memory (e.g., memory 418 also corresponding to memory 118 of co-processor 111) is mapped separately from and managed separately from a main system memory (e.g., memory 120). A translation block 450 can therefore include guest page table 430 and frame buffer mapping table 440 for memory 418. A control circuit (e.g., control circuit 112 and/or security processor 116) can accordingly use guest page table 430 and frame buffer mapping table 440 for ownership checks, as described herein.

FIG. 5 illustrates a system 500 that corresponds to system 100. System 500 includes a client 514 corresponding to client 114, a GPU memory pipeline 522 corresponding to GPU memory pipeline 222, a memory controller 524 corresponding to memory controller 224, and a memory 518 corresponding to memory 218. System 500 also includes a guest page table 530 corresponding to guest page table 230, and a reverse mapping table 540 corresponding to mapping table 240.

In some examples, system 500 corresponds to a GPU in which its memory (e.g., memory 518 also corresponding to memory 118 of co-processor 111) is mapped together with and managed together with a main system memory (e.g., memory 120). A translation block 550 includes guest page table 530 and an address translation cache 554. A memory management unit 552 includes reverse mapping table 540 for memory 518 and the main system memory. A control circuit (e.g., control circuit 112 and/or security processor 116) can use guest page table 530 and address translation cache 554 (e.g., a cache for storing recent translations of guest physical memory addresses to physical memory addresses) for translating virtual addresses, with memory management unit 552 providing translations, using reverse mapping table 540, for misses in address translation cache 554. However, in some implementations, if guest page table 530 indicates an encrypted page (e.g., via an encryption status such as encryption status 338), the control circuit can bypass address translation cache 554 to determine an ownership status (e.g., ownership status 348) as stored in reverse mapping table 540. Thus, the control circuit can accordingly use guest page table 530 and reverse mapping table 540 (e.g., via memory management unit 552) for ownership checks, as described herein. However, in some implementations, the ownership status can also be stored in address translation cache 554.

FIG. 6 is a flow diagram of an exemplary computer-implemented method 600 for confidential computing ownership checks for GPU memory. The steps shown in FIG. 6 can be performed by any suitable circuit, device and/or computing system, including the system(s) illustrated in FIGS. 1, 2, 4, and/or 5. In one example, each of the steps shown in FIG. 6 represent an algorithm whose structure includes and/or is represented by multiple sub-steps, examples of which will be provided in greater detail below.

As illustrated in FIG. 6, at step 602 one or more of the systems described herein receive a translation request including a guest identifier and a virtual address. For example, control circuit 112 receives a translation request as part of a memory operation, that can include a guest identifier (e.g., guest identifier 332) and a virtual address (e.g., virtual address 334). More specifically, at a guest level, an intermediary request may include a process ID (e.g., identifying a process on the guest) and the virtual address for translating into a guest physical address, as in step 604 described further below. At a host level, another intermediary request may include the guest physical address and a guest virtual machine (VM) identifier (e.g., VFID which can correspond to guest identifier 332) for translating into a final physical address, as in step 606 described further below.

At step 604 one or more of the systems described herein determine a guest physical address from the virtual address and the guest identifier. For example, control circuit 112 can determine a guest physical address (e.g., guest physical address 336) from the virtual address and the guest identifier.

At step 606 one or more of the systems described herein determine a final physical address from the guest physical address. For example, control circuit 112 can determine a final physical address (e.g., final physical address 346) from the guest physical address. In some examples, the final physical address can correspond to a physical location in a memory of a GPU (e.g., memory 118 of co-processor 111).

At step 608 one or more of the systems described herein determine the guest identifier passes an ownership check for the final physical address. For example, control circuit 112 can determine that the guest identifier passes an ownership check for the final physical address, for instance by confirming that encryption status 338 is consistent with ownership status 348.

At step 610 one or more of the systems described herein return the final physical address in response to the guest identifier passing the ownership check. For example, control circuit 112 can return the final physical address if the guest identifier passes the ownership check and can send a fault otherwise.

As detailed above, extending confidential computing to GPU hardware can require enforcing ownership of guest pages in GPU memory. Confidential computing allows a guest VM to extend/expose its confidential data to the GPU to take advantage of the GPU's processing power. The GPU can guarantee that guest data is kept confidential and further protect the guest data's integrity, in the context of a hypervisor considered untrusted in a security model. The guest data can be kept confidential using encryption at the memory controller. The guest data is integrity protected by a system of ownership checks.

For confidential computing, the guest can identify which virtual memory pages contain sensitive data, for example by setting a per-page attribute bit in a guest page table. Using secure methods (which can involve a security processor), the guest and host can identify which physical pages belong to the guest (which will be encrypted) as opposed to belonging to the host (which is shared between guests and the hypervisor and is generally unencrypted).

As detailed above, a translation subsystem can made aware of or otherwise tracks the ownership of physical pages in host page tables. The translation subsystem will allow/return SUCCESS or disallow/return FAULT based at least on the guest VM ID (e.g., guest identifier 332) and an ownership bit that can be stored in a translation lookaside buffer (TLB).

As detailed above, the circuits, devices, computing devices and systems described and/or illustrated herein broadly represent any type or form of computing device or system capable of executing computer-readable instructions. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A device comprising:
a control circuit of memory pipeline of a graphics processing unit that is configured to:
translate, in response to a translation request including a virtual address and a guest identifier of a guest virtual machine, the virtual address to a final physical address, wherein the final physical address corresponds to a physical location in a memory in the graphics processing unit that is physically separate from a main system memory;
confirm, using the guest identifier, that the guest virtual machine has an ownership privilege of the final physical address; and
return, in response to the confirmation, the final physical address.

2. The device of claim 1, wherein the control circuit is further configured to return an ownership status indicating the ownership privilege with the final physical address.

3. The device of claim 1, wherein the control circuit is further configured to return an encryption status with the final physical address.

4. The device of claim 1, wherein the control circuit is configured to translate the virtual address by translating a corresponding guest physical address using a reverse mapping table that maps the memory of the graphics processing unit with a system memory.

5. The device of claim 1, wherein the control circuit is configured to translate the virtual address using a frame buffer mapping table that maps memory of the graphics processing unit separately from a system memory.

6. The device of claim 1, wherein translating the virtual address to the final physical address comprises:
translating, using a guest page table, the virtual address to a guest physical address; and
translating, using a mapping table, the guest physical address to the final physical address.

7. The device of claim 6, confirming that the guest virtual machine has the ownership privilege further comprises:
determining, using the guest page table, that the final physical address corresponds to an encrypted memory location; and
determining, using the mapping table and in response to the final physical address corresponding to the encrypted memory location, that the guest virtual machine has the ownership privilege of the final physical address.

8. The device of claim 6, wherein the guest page table includes an encryption status, and the mapping table includes an ownership status.

9. The device of claim 8, wherein the control circuit is configured to convert a second virtual address to a private encrypted memory by updating the corresponding encryption status and ownership status.

10. The device of claim 1, wherein the control circuit is further configured to return a fault in response to the guest identifier failing ownership confirmation.

11. A system comprising:
a main system memory;
a processor coupled to the main system memory; and
a graphics processing unit separate from the processor and comprising:
a graphics processing unit memory separate from the main system memory; and
a control circuit configured to:
translate, in response to a translation request including a virtual address and a guest identifier of a guest virtual machine, the virtual address to a final physical address corresponding to a physical location in the graphics processing unit memory;
confirm, using the guest identifier and based on an ownership status associated with the final physical address in a mapping table, the guest virtual machine has an ownership privilege of the final physical address; and
return, in response to the confirmation, the final physical address.

12. The system of claim 11, wherein the control circuit is further configured to return an encryption status with the final physical address.

13. The system of claim 11, wherein the mapping table corresponds to a reverse mapping table that maps the graphics processing unit memory with the memory.

14. The system of claim 11, wherein the mapping table corresponds to a frame buffer mapping table that maps the graphics processing unit memory separately from the memory.

15. The system of claim 11, wherein translating the virtual address to the final physical address comprises:
translating, using a guest page table, the virtual address to a guest physical address; and
translating, using the mapping table, the guest physical address to the final physical address.

16. The system of claim 15, confirming the guest virtual machine has the ownership privilege further comprises:
determining, using the guest page table, that the final physical address corresponds to an encrypted memory location; and
determining, using the mapping table, that the guest virtual has the ownership privilege of the final physical address.

17. The system of claim 15, wherein the guest page table includes an encryption status.

18. The system of claim 17, wherein the control circuit is configured to convert a second virtual address to a private encrypted memory by updating the corresponding encryption status and ownership status.

19. The system of claim 11, wherein the control circuit is further configured to return a fault in response to the guest identifier failing ownership confirmation.

20. A method comprising:
receiving, by a memory controller of a graphics processing unit, a translation request as part of a memory request from a central processing unit, wherein the translation request includes a guest identifier and a virtual address;
determining a guest physical address from the virtual address and the guest identifier;
determining a final physical address from the guest physical address, wherein the final physical address corresponds to a physical location in a memory in the graphics processing unit that is separate from a main system memory;
determining the guest identifier passes an ownership check for the final physical address; and
returning the final physical address in response to the guest identifier passing the ownership check.
